(19) United States
(12) Patent Application Publication
(10) Pub. No.: US 2024/0348684 A1
(43) Pub. Date: Oct. 17, 2024

(54) CLOUD DESKTOP DATA MIGRATION METHOD, SERVICE NODE, MANAGEMENT NODE, SERVER, ELECTRONIC DEVICE, AND COMPUTER-READABLE STORAGE MEDIUM

(71) Applicant: ZTE CORPORATION, Shenzhen, Guangdong (CN)

(72) Inventor: Baiying CHEN, Shenzhen, Guangdong (CN)

(21) Appl. No.: 18/294,657

(22) PCT Filed: May 19, 2022
(86) PCT No.: PCT/CN2022/093910

§ 371 Date: Feb. 2, 2024

(30) Foreign Application Priority Data
Aug. 2, 2021 (CN) 202110879884.2

(51) Int. Cl. H04L 67/1097; H04L 67/06

(52) U.S. Cl. CPC H04L 67/1097; H04L 67/06

(57) ABSTRACT

The present application provides a cloud desktop data migration method, a service node, a management node, a server, an electronic device, and a computer-readable storage medium. The cloud desktop data migration method includes: determining, according to attribute information of a cloud desktop logged in by a terminal, whether to migrate user data, where the attribute information of the cloud desktop logged in by the terminal is information determined according to acquired configuration information of a management node; determining, when it is determined to migrate the user data, hotspot data according to access popularity corresponding to the user data; and migrating the hotspot data.

### CROSS-REFERENCE TO RELATED APPLICATIONS

This application claims priority to Chinese patent application No. 202110879884.2 filed on Aug. 2, 2021, the entirety of which is incorporated hereby by reference.

### TECHNICAL FIELD

The present application relates to the field of computer technologies, and specifically relates to a cloud desktop data migration method, a service node, a management node, a server, an electronic device, and a computer-readable storage medium.

### BACKGROUND

The cloud desktop is a basic use scenario of cloud computing, in which a plurality of virtual desktops are operated on a physical server. When using the cloud desktop for work, a user can access a virtual machine desktop in a network through a terminal, thereby replacing the conventional terminal devices such as a desktop computer, a laptop, or the like. By establishing the cloud desktop across multiple devices, different use scenarios of users at different locations can be satisfied, and when the user switches or roams among a plurality of cloud desktops, user data should be switched or roamed together with the cloud desktop, so that the user can continuously use the user data specific to him/her.

Current roaming of the cloud desktop requires resources corresponding to an original cloud desktop to be completely migrated to a local device of a new desktop, or implements roaming of the cloud desktop through a mirrored cloud desktop, which has the problems of long migration period, high network bandwidth occupation, high storage resource occupation, and the like.

### SUMMARY

In a first aspect, an embodiment of the present application provides a cloud desktop data migration method applied to a service node, which includes: determining, according to attribute information of a cloud desktop logged in by a terminal, whether to migrate user data, wherein the attribute information of the cloud desktop logged in by the terminal is information determined according to acquired configuration information of a management node; determining, when it is determined to migrate the user data, hotspot data according to access popularity corresponding to the user data; and migrating the hotspot data.

In a second aspect, an embodiment of the present application provides a cloud desktop data migration method applied to a management node, which includes: generating configuration information according to acquired attribute information of a cloud desktop logged in by a terminal; and sending the configuration information to a service node so that the service node determines, according to the attribute information of the cloud desktop logged in by the terminal, whether to migrate user data, and when it is determined to migrate the user data, determines hotspot data according to access popularity corresponding to the user data, and migrates the hotspot data.

In a third aspect, an embodiment of the present application provides a service node, including: a first determination module configured to determine, according to attribute information of a cloud desktop logged in by a terminal, whether to migrate user data, wherein the attribute information of the cloud desktop logged in by the terminal is information determined according to acquired configuration information of a management node; a second determination module configured to determine, when it is determined to migrate the user data, hotspot data according to access popularity corresponding to the user data; and a migration module configured to migrate the hotspot data.

In a fourth aspect, an embodiment of the present application provides a management node, including: a generation module configured to generate configuration information according to acquired attribute information of a cloud desktop logged in by a terminal; and a configuration module configured to send the configuration information to a service node so that the service node determines, according to the attribute information of the cloud desktop logged in by the terminal, whether to migrate user data, and when it is determined to migrate the user data, determines hotspot data according to access popularity corresponding to the user data, and migrates the hotspot data.

In a fifth aspect, an embodiment of the present application provides a server, including: a service node and/or a management node; wherein the service node is configured to implement the cloud desktop data migration method according to the first aspect of the present application; and the management node is configured to implement the cloud desktop data migration method according to the second aspect of the present application.

In a sixth aspect, an embodiment of the present application provides an electronic device, including: one or more processors; a memory having one or more computer programs stored thereon which, when executed by the one or more processors, cause the one or more processors to implement the cloud desktop data migration method according to any embodiment of the present application.

In a seventh aspect, an embodiment of the present application provides a computer-readable storage medium having a computer program stored thereon which, when executed by a processor, causes the cloud desktop data migration method according to any embodiment of the present application to be implemented.

With respect to the above embodiments and other aspects of the present application and implementations thereof, further description is provided in the brief description of drawings, the detailed description of embodiments, and the claims.

### BRIEF DESCRIPTION OF DRAWINGS

FIG. 1 shows a schematic flowchart of a cloud desktop data migration method according to an embodiment of the present application.

FIG. 2 shows a schematic flowchart of a cloud desktop data migration method according to an embodiment of the present application.

FIG. 3 shows a schematic flowchart of a cloud desktop data migration method according to an embodiment of the present application.

FIG. 4 shows a schematic structural diagram of a service node according to an embodiment of the present application.

FIG. 5 shows a schematic structural diagram of a management node according to an embodiment of the present application.

FIG. 6 shows a schematic structural diagram of a server according to an embodiment of the present application.

FIG. 7 shows schematic network connection between devices in a cloud desktop data migration system according to an embodiment of the present application.

FIG. 8 shows a schematic structural diagram of modules in a cloud desktop data migration system according to an embodiment of the present application.

FIG. 9 shows a schematic structural diagram of a storage unit according to an embodiment of the present application.

FIG. 10 is a schematic flowchart of a method for migrating hotspot data by a service node according to an embodiment of the present application.

FIG. 11 is a schematic flowchart of a method for reading user data by a terminal through a second type cloud desktop according to an embodiment of the present application.

FIG. 12 is a schematic flowchart of a method for reading user data by a terminal through a shared cloud desktop according to an embodiment of the present application.

FIG. 13 is a schematic flowchart of a method for writing hotspot data by a terminal through a second type cloud desktop according to an embodiment of the present application.

FIG. 14 is a schematic flowchart of a method for clearing a storage unit corresponding to a second type cloud desktop according to an embodiment of the present application.

FIG. 15 is a block diagram showing an exemplary hardware architecture of a computing device capable of implementing the cloud desktop data migration method and apparatus according to an embodiment of the present application.

### DETAIL DESCRIPTION OF EMBODIMENTS

For clarity and better understanding of the objects, technical solution and advantages of the application, embodiments of the present application will now be described in detail in conjunction with the accompanying drawings. It should be noted that the embodiments of the present application and features therein may be combined with each other in any manner as long as they are not contradictory.

By establishing the cloud desktop across multiple devices, different use scenarios of users at different locations can be satisfied, and when the user switches or roams among a plurality of cloud desktops, user data should be switched or roamed together with the cloud desktop, so that the user can continuously use the user data specific to him/her.

At present, to migrate user data corresponding to a cloud desktop, resources corresponding to an original cloud desktop may be completely migrated to a local device of a new desktop. However, since the user will not modify or use all the data every time, lots of data in the migrated data are not accessed by the user. Moreover, migration of all data will waste a large amount of network bandwidth resources, resulting in a long data migration period and high storage resource occupation. Roaming of the cloud desktop may also be implemented through a mirrored cloud desktop, but the network delay between data centers at different places may be up to dozens of milliseconds, and when a second type cloud desktop accesses a data storage unit at a different place, the problems of prolonged access time delay and poor user experience will occur. A service node corresponding to the second type cloud desktop logged in by the user is a roaming service node, which is located at a different geographical location from a home service node.

A first aspect of the present application provides a cloud desktop data migration method.

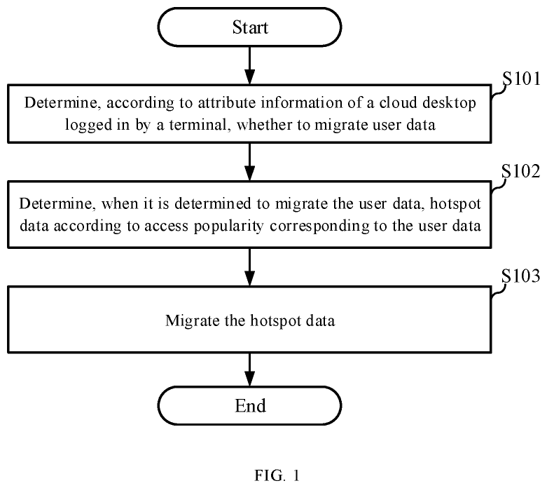

FIG. 1 shows a schematic flowchart of a cloud desktop data migration method according to an embodiment of the present application. The cloud desktop data migration method may be applied to a service node which may be arranged in a server. As shown in FIG. 1, the cloud desktop data migration method according to the embodiment of the present application may include the following operations S101 to S103.

At operation S101, determining, according to attribute information of a cloud desktop logged in by a terminal, whether to migrate user data.

The attribute information of the cloud desktop logged in by the terminal is information determined according to acquired configuration information of a management node. The attribute information of the cloud desktop may include: a positional relationship between the cloud desktop and the home service node to which the cloud desktop belongs,

For example, whether a distance between the cloud desktop and the home service node exceeds a preset distance threshold, e.g., whether the cloud desktop and the home service node are in the same city, or whether the cloud desktop and the home service node are located at the same data center, or the like.

For example, the management node sends configuration information to the service node, or the service node actively acquires configuration information from the management node. The configuration information may include attribute information of the cloud desktop, including a type of the cloud desktop, e.g., a first type cloud desktop and/or a second type cloud desktop. A service node of the home location corresponding to a user account logging in the first type cloud desktop is a home service node, a service node corresponding to logging in the second type cloud desktop is a roaming service node, and the roaming service node is located at a different geographical location from the home service node.

At operation S102, determining, when it is determined to migrate the user data, hotspot data according to access popularity corresponding to the user data.

The access popularity is a value representing an access frequency of the user data, and data frequently used by a user in the user data can be found according to the access popularity corresponding to the user data, so that the hotspot data can be obtained by screening from the user data, thereby facilitating processing of the hotspot data by the user.

At operation S103, migrating the hotspot data.

The hotspot data may be downloaded to the local storage unit corresponding to the cloud desktop logged in by the user, or the hotspot data is mirrored to the local storage unit corresponding to the cloud desktop logged in by the user, so that it is not necessary to migrate all data of the user, and the migrated data volume is reduced.

For example, the user data includes 100 files, of which only 10 files are included in the hotspot data, so that instead of downloading all the 100 files, only the 10 hotspot files are desired to be downloaded to the local storage unit corresponding to the cloud desktop logged in by the user, which reduces the downloaded data volume, avoids network bandwidth waste, while improving the access efficiency of the hotspot data.

In the cloud desktop data migration method provided in the present application, whether to migrate user data is determined according to the attribute information of the cloud desktop logged in by the terminal, so as to ensure that the terminal can rapidly acquire the hotspot data; and when it is determined to migrate the user data, instead of migrating all the user data, hotspot data is determined according to access popularity of the user data and then migrated, which can reduce the migrated data volume, avoid high network bandwidth occupation in the process of data migration, and reduce the migration period.

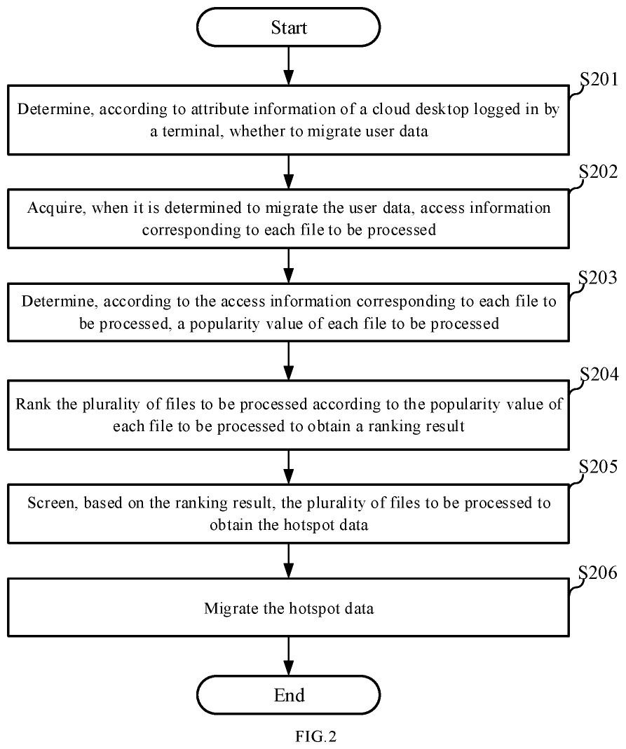

FIG. 2 shows a schematic flowchart of a cloud desktop data migration method according to an embodiment of the present application. The cloud desktop data migration method may be applied to a service node which may be arranged in a server. The cloud desktop data migration method shown in FIG. 2 differs from that of FIG. 1 in that: the user data includes a plurality of files to be processed; and the method includes: determining, according to the access information corresponding to each file to be processed, a popularity value of each file to be processed, and then ranking the plurality of files to be processed according to the popularity value of each file to be processed to screen the hotspot data from the plurality of files to be processed.

As shown in FIG. 2, the cloud desktop data migration method according to the embodiment of the present application may include the following operations S201 to S206.

At operation S201, determining, according to attribute information of a cloud desktop logged in by a terminal, whether to migrate user data.

In some implementations, determining, according to attribute information of the cloud desktop logged in by the terminal, whether to migrate user data includes: determining to migrate the user data when it is determined that the desktop roaming identifier corresponding to the cloud desktop logged in by the terminal represents that a user account logged in the cloud desktop supports data roaming.

In some implementations, the attribute information of the cloud desktop includes: a desktop roaming identifier, where the desktop roaming identifier represents whether a user account logging in the cloud desktop supports data roaming.

It should be noted that different from the first type cloud desktop, for the second type cloud desktop, a service node of the home location corresponding to a user account logging in the first type cloud desktop is a home service node, a service node where the second type cloud desktop is logged in is a roaming service node, and the roaming service node is located at a different geographical location from the home service node. If the user data desired by the terminal is not stored in the storage unit corresponding to the second type cloud desktop, the hotspot data in the storage unit corresponding to the first type cloud desktop has to be migrated to the storage unit corresponding to the second type cloud desktop, so that the efficiency of data acquisition by the second type cloud desktop is increased, and the user experience is improved.

At operation S202, acquiring, when it is determined to migrate the user data, access information corresponding to each file to be processed.

The user data includes a plurality of files to be processed, each of which corresponds to different pieces of access information. For example, the access information corresponding to the file to be processed may include: any one or more of a data type of the file to be processed, time information of the file to be processed, access path information of the file to be processed, or a data volume of the file to be processed.

By reflecting the access information corresponding to the file to be processed through various information, the access condition of a user to the file to be processed can be comprehensively measured, and the processing efficiency of the file to be processed can be increased.

At operation S203, determining, according to the access information corresponding to each file to be processed, a popularity value of each file to be processed.

The popularity value of the file to be processed may be determined by combining any one or more of the data type of the file to be processed, time information of the file to be processed, access path information of the file to be processed, or the data volume of the file to be processed in the access information. By determining the popularity value of each file to be processed through a combination of different pieces of access information or access information, features of different files to be processed can be embodied, and accuracy of the popularity value of each file to be processed can be ensured.

In some implementations, the time information of the file to be processed includes: historical access time of the file to be processed; and determining, according to the access information corresponding to each file to be processed, the popularity value of each file to be processed includes: acquiring current time; determining a time weight according to the historical access time of the file to be processed and the current time; and determining a popularity value of the file to be processed according to the time weight and the data volume of the file to be processed.

In some implementations, a difference between the historical access time of the file to be processed and the current time may be calculated to obtain a time difference; and then a time weight may be obtained according to the time difference. For example, the access popularity of each file to be processed in the last n days is counted, where n is an integer greater than or equal to 1. Let y be a difference (e.g., number of days) between the historical access time and the current time, and the time weight is W_Time_y, where y is an integer greater than or equal to 0 and less than or equal to (n−1). For example, assuming that n is equal to 7, when the difference between the historical access time and the current time is 0 (i.e., when y is 0), the file to be processed has a maximum time weight W_Time_0, i.e., 1; when the difference between the historical access time and the current time is 1 (i.e., when y is 1), the file to be processed has a time weight W_Time_1= 6/7; and when the difference between the historical access time and the current time is y, the file to be processed has a time weight W_Time_y=(7−y)/7.

The above unit of n or y is merely illustrative, and for example, the access popularity of each file to be processed in the last n hours may be counted when needed, in which case y may be the number of hours.

Then, the number of bytes of the file to be processed accessed each time within a preset time period is weighted by the time weight, and then a sum thereof is calculated to obtain a popularity value of each file to be processed. Therefore, the popularity value can reflect both an access frequency and a data volume of each file to be processed, so that important files can be preferentially accessed, and the access efficiency of data is improved.

At operation S204, ranking the plurality of files to be processed according to the popularity value of each file to be processed to obtain a ranking result.

In some implementations, the ranking result includes: an ID and a popularity value of each file to be processed.

A magnitude of the popularity value of each file to be processed can reflect whether the file to be processed is accessed, an access frequency of the file to be processed, or other information. A larger popularity value of the file to be processed indicates a higher access frequency of the file to be processed. In other words, the more frequently a file to be processed is used by a user, the more important the file to be processed is.

At operation S205, screening, based on the ranking result, the plurality of files to be processed to obtain the hotspot data.

Based on the popularity values in the ranking result, files among the plurality of files to be processed with larger popularity values are screened and determined as the hotspot data according to IDs of the files to be processed.

For example, according to a migrated volume of the user data configured by the management node, the hotspot data ranked high in the ranking result (for example, the top 10 pieces of hotspot data in the ranking result) is migrated; and if a data volume of the hotspot data is smaller than the migrated volume of the user data, all the hotspot data are migrated, so that the user can obtain the hotspot data while avoiding occupying too much network bandwidth in the data migration process, thereby reducing the migration period.

At operation S206, migrating the hotspot data.

It should be noted that operation S206 is the same as operation S103 in FIG. 1, and thus is not repeated here.

In the cloud desktop data migration method provided in the present application, when it is determined to migrate the user data, access information corresponding to each file to be processed is acquired to comprehensively measure the access condition of a user to the file to be processed, and increase the processing efficiency of the file to be processed. According to the access information corresponding to each file to be processed, the popularity value of each file to be processed is determined, so that features of different files to be processed can be embodied, and accuracy of the popularity value of each file to be processed can be ensured. The plurality of files to be processed are ranked according to the popularity value of each file to be processed, to obtain a ranking result which can reflect whether each file to be processed is accessed, an access frequency of each file to be processed, or other information. According to the ranking result, hotspot data are screened from the plurality of files to be processed and migrated, so that the user can obtain the hotspot data while avoiding occupying too much network bandwidth in the data migration process, thereby reducing the migration period.

In some implementations, determining, according to the access information corresponding to each file to be processed, the popularity value of each file to be processed in operation S203 may be implemented by: determining, according to the data type of the file to be processed, a weight of the data type corresponding to the file to be processed; and determining a popularity value of the file to be processed according to the weight of the data type, the data volume of the file to be processed, a time weight in the time information of the file to be processed, and a path weight in the access path information of the file to be processed.

The data type of the file to be processed may include any one or more of a text file, an image file, an email, or a video file. Different weights may be set for different data types. It should be noted that the data types of the file to be processed described above are merely illustrative and may be specifically set according to actual needs, and other data types not mentioned herein are also within the protection scope of the present application, which are not described in detail here.

For example, weights of m data types are set, and each data type may have a weight represented as W_Type_x, where x is an integer greater than or equal to 1 and less than or equal to m, and m is an integer greater than or equal to 1. For example, W_Type_0 is set to be a weight of a default data type, e.g., W_Type_0 is set to 0.1; W_Type_1 is set to represent a weight of the data type of text file, where for example, for any one or more of text file types such as word, excel, ppt, pdf, txt and the like, W_Type_1 is set to 1; W_Type_2 is set to represent a weight of the data type of email, where for example, W_Type_2 may be set to 1; W_Type_3 is set to represent a weight of an image or picture file, where for example, W_Type_3 may be set to 0.8; and W_Type_4 is set to represent a weight of a video file, where for example, W_Type_4 may be set to 0.5.

For another example, if the data type of the file to be processed is text data, the weight of the data type of the file to be processed may be set to 0.2; if the data type of the file to be processed is image data, the weight of the data type of the file to be processed may be set to 0.3; if the data type of the file to be processed is video data, the weight of the data type of the file to be processed may be set to 0.6, so on and so forth.

The weights of different data types can reflect importance degrees of the data types, so that important files can be preferentially accessed, and the access efficiency of data is improved.

The path weight in the access path information of the file to be processed may be determined according to a type of the accessed file.

For example, the path weight may be set as follows: for example, path weights of z access paths are set to W_Path_z, respectively, where z is an integer greater than or equal to 1. For example, if an access path 1 is a path corresponding to a system file (e.g., the access path C:/windows, or the like), a path weight W_Path_1 of the access path 1 may be set to 0; and if an access path 2 is not a system file (e.g., D:/w/zy/er, or the like), a path weight W_Path_2 of the access path 2 may be set to 1.

It should be noted that when the path weight is determined to be 1, it indicates that all files in the access path are counted, and when the path weight is determined to be 0, it indicates that none of the files in the access path are counted. In other words, the system file corresponding to the access path with the path weight 0 should be filtered out, so as to avoid statistical errors caused by too many system files, and improve the accuracy of the file popularity value.

In some implementations, the cloud desktop data migration method further includes: after determining, according to attribute information of the cloud desktop logged in by the terminal, whether to migrate user data, reading the user data in a storage unit corresponding to the service node.

The service node includes: a home service node, or the home service node and a roaming service node, where the home service node is a service node for a user account at a home location, and the roaming service node is a service node for the user account at a roaming location.

For example, if the terminal is bound to a registered user and the home location corresponding to the registered user is Beijing, then the home location corresponding to the terminal is Beijing; if the registered user logs in the terminal at the home location, the terminal accesses a storage unit on a home service node so that the registered user can obtain the user data desired by the registered user; and if the registered user moves to another city (e.g., Shanghai, or the like), for example, the registered user logs in a certain terminal in Shanghai, the terminal has to be connected to a roaming service node so that the roaming service node can be connected to the home service node corresponding to the registered user, and the registered user can obtain the desired hotspot data.

It should be noted that the terminal may not be bound to a certain registered user, the user may log in a cloud desktop through any terminal, and one terminal may be used by any user to log in a cloud desktop, where different types of cloud desktops are distinguished and entered according to setting information of the user account, and a corresponding cloud desktop is displayed to the user.

Under the condition of determining that the terminal is connected to a roaming service node, the terminal can obtain the hotspot data from a local storage unit corresponding to the roaming service node, or obtain the hotspot data through communication information between the terminal and the home service node. Therefore, the registered user can use the hotspot data normally, and the user experience is improved.

In some implementations, the storage unit corresponding to the service node includes: a shared storage unit corresponding to the home service node, and a local storage unit corresponding to the roaming service node; and reading the user data in the storage unit corresponding to the service node includes: when it is determined that the user data is stored in the local storage unit corresponding to the roaming service node, reading the user data from the local storage unit corresponding to the roaming service node; and when it is determined that the user data is not stored in the local storage unit corresponding to the roaming service node, reading the user data from the shared storage unit corresponding to the home service node.

By reading the user data from the local storage unit corresponding to the roaming service node, the terminal can conveniently obtain the user data. However, if the terminal logs in a roaming service node and the user data is not stored in the local storage unit corresponding to the roaming service node, the home service node has to interact with the roaming service node so that the roaming service node can read the user data from a shared storage unit corresponding to the home service node. Thereby, the terminal can rapidly obtain the user data, and the user experience can be improved.

In some implementations, migrating the hotspot data includes: migrating the hotspot data stored in the shared storage unit corresponding to the home service node to the storage unit corresponding to the roaming service node.

When the terminal logs in a roaming service node, it is not necessary to migrate all user data stored in the shared storage unit corresponding to the home service node to the roaming service node, thereby saving the network bandwidth in the data transmission process. In addition, by migrating the hotspot data stored in the shared storage unit corresponding to the home service node to the storage unit corresponding to the roaming service node, the problems of severe network delay in long-distance data transmission can be avoided, and the data access efficiency can be effectively improved.

In some implementations, the cloud desktop data migration method further includes: after migrating the hotspot data, acquiring updated data fed back from the terminal.

After obtaining the hotspot data, the terminal may process the hotspot data, update the hotspot data into updated data, and then feed the updated data back to the service node.

For example, in the case of determining that the terminal logs in a roaming service node, the updated data has to be transmitted from a local storage unit of the roaming service node to a shared storage unit in the home service node corresponding to the terminal; and in the case of determining that the terminal logs in a home service node, the updated data has to be transmitted from the local storage unit of the home service node corresponding to the terminal to the shared storage unit in the home service node, so as to ensure that the user data stored in the shared storage unit of the home service node is updated in time, and that only one complete set of the user data is stored in the shared storage unit of the home service node across the whole network, thereby avoiding waste of storage resources.

In some implementations, the cloud desktop data migration method further includes: before transmitting the updated data to the shared storage unit of the home service node, acquiring a cache identifier sent from a management node; and determining, according to the cache identifier, whether to cache the updated data to the roaming service node.

The cache identifier represents whether the terminal caches the updated data corresponding to the second type cloud desktop. For example, when the cache identifier is 1, it may be determined that the terminal caches the updated data corresponding to the second type cloud desktop; and when the cache identifier is 0, it may be determined that the terminal does not cache the updated data corresponding to the second type cloud desktop. The above values of the cache identifier are merely illustrative, and may be set according to the actual situation, and values of other cache identifiers that are not described are also within the protection range of the present application, which are not described in detail here.

By acquiring the cache identifier sent from the management node, it is determined whether to cache the updated data to the roaming service node, so that the waste of storage resources caused by storing the updated data in different places can be avoided, while ensuring that the updated data is stored in time and ensuring the accuracy of data.

In some implementations, determining, according to the cache identifier, whether to cache the updated data to the roaming service node includes: when it is determined that the cache identifier indicates that the updated data is to be cached to the roaming service node, caching the updated data to a local storage unit corresponding to the roaming service node, and synchronizing the updated data to a shared storage unit corresponding to the home service node; and when it is determined that the cache identifier indicates that the updated data is not to be cached to the roaming service node, transmitting the updated data to the shared storage unit corresponding to the home service node.

The updated data is stored at different storage positions under different conditions, so that the user can acquire the updated data in time, and the transmission delay of the data is reduced. Moreover, the updated data is transmitted or synchronized to the shared storage unit corresponding to the home service node at any condition, so that the user data stored in the shared storage unit corresponding to the home service node can be updated in time, and the accuracy of the data is improved.

In some implementations, caching the updated data to the local storage unit corresponding to the roaming service node includes: accumulating access popularity corresponding to the updated data according to access information corresponding to the updated data; and caching the updated data and the corresponding access popularity to the local storage unit corresponding to the roaming service node.

By calculating and accumulating the access popularity corresponding to the updated data with the access information of the updated data, the access popularity corresponding to the updated data is more accurate, and the updated data can be ensured to be obtained in time when accessed next time. Further, the updated data and the corresponding access popularity are both cached to the local storage unit corresponding to the roaming service node, so that the terminal can obtain the updated data in time without accessing the shared storage unit corresponding to the terminal again, thereby reducing remote data transmission and improving the access efficiency of the data.

In some implementations, the shared storage unit corresponding to the home service node includes: any one or more of a network attached storage device, a distributed file storage device, or a cloud storage; and the local storage unit corresponding to the roaming service node includes: any one or more of a redundant array of independent disks (RAID), a distributed storage device or a hard disk.

The network attached storage device may be a dedicated data storage server which takes data as a center, completely separates the storage device from the server, and performs centralized management on the data, thereby reducing the dependence on network bandwidth, improving the storage performance and reducing the maintenance cost.

The RAID is a disk group of a huge capacity consisting of a plurality of independent disks, which improves the performance of the entire disk system through additive effects generated by individual disks providing data. Data can be divided into a plurality of segments by RAID, and different segments of data are stored on respective hard disks, so that the data can be accessed in blocks, the mechanical seek time of the disk is reduced, and the data access speed is increased. Further, redundancy protection of the data is implemented in a mirroring mode or by storing parity information.

The distributed file storage device adopts an extensible storage structure, shares a storage load among a plurality of storage devices, and positions storage information by a position server, which can not only improve the reliability, availability and access efficiency of the data storage, but also is easy to extend.

In some implementations, the cloud desktop data migration method further includes: after migrating the hotspot data, when it is determined that the service node includes the home service node and the roaming service node, clearing data in a local storage unit corresponding to the roaming service node.

Data in the local storage unit corresponding to the roaming service node is cleared to avoid excessive useless data stored in the local storage unit corresponding to the roaming service node, and improve the use efficiency of the local storage unit corresponding to the roaming service node.

It should be noted that the local storage unit corresponding to the roaming service node has limited storage space, and by clearing data in the local storage unit corresponding to the roaming service node, it can be ensured that more cache space is obtained for the timely updated data, thereby avoiding loss of the updated data and improving the accuracy of the data.

In some implementations, clearing data in the local storage unit corresponding to the roaming service node includes: determining a cache proportion according to the acquired capacity of a cache space in the local storage unit corresponding to the roaming service node and a cached data volume; determining, according to the cache proportion and a preset clearing threshold, whether to clear data in the cache space of the local storage unit corresponding to the roaming service node; and when it is determined to clear data in the cache space of the local storage unit corresponding to the roaming service node, clearing the data in the cache space of the local storage unit corresponding to the roaming service node according to access popularity and a preset popularity threshold of the data in the cache space of the local storage unit corresponding to the roaming service node.

The cache proportion may represent whether the cache space of the local storage unit corresponding to the roaming service node is in a saturated state, so as to avoid the case that there is no cache space available for the updated data, and the cache proportion is compared with a preset clearing threshold to determine whether to clear data in the cache space of the local storage unit corresponding to the roaming service node, and when it is determined to clear data in the cache space of the local storage unit corresponding to the roaming service node, data in the cache space of the local storage unit corresponding to the roaming service node is cleared to save storage resources.

It should be noted that in the process of clearing data in the cache space of the local storage unit corresponding to the roaming service node, the data in the cache space of the local storage unit corresponding to the roaming service node may be further ranked according to access popularity of the data in the cache space of the local storage unit corresponding to the roaming service node, to obtain data with a lower access popularity; and then, the data with a lower access popularity is screened through a preset popularity threshold, thereby clearing useless data with a lower access popularity.

For example, the cache space capacity is 500 MB, the cache space clearing threshold is 90%, and the cached data volume is 480 MB, which accounts for 96% of the cache space capacity and exceeds the cache space clearing threshold 90%, therefore, according to the ranking of the data in the cache space based on the popularity value, 30 MB of the data with lower popularity values is cleared to save storage resources.

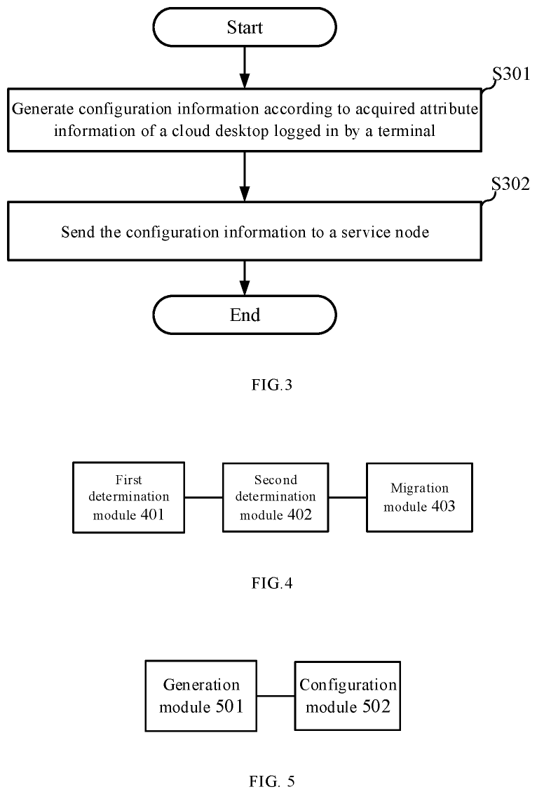

A second aspect of the present application provides a cloud desktop data migration method. FIG. 3 shows a schematic flowchart of a cloud desktop data migration method according to an embodiment of the present application. The cloud desktop data migration method may be applied to a management node which may be arranged in a server. As shown in FIG. 3, the cloud desktop data migration method according to the embodiment of the present application may include the following operations S301 to S302.

At operation S301, generating configuration information according to acquired attribute information of a cloud desktop logged in by a terminal.

In some implementations, the configuration information includes: any one or more of a desktop roaming identifier, a storage address, a migrated volume of the user data, a cache identifier, a capacity of a cache space of a service node, a clearing period of the cache space of the service node, or a preset clearing threshold. The desktop roaming identifier represents whether a user account logging in the cloud desktop supports data roaming, the cache identifier represents whether to cache the updated user data, and the capacity of the cache space of the service node is larger than or equal to the migrated volume of the user data.

It should be noted that different cloud desktops correspond to different types of configuration information. For example, the configuration information corresponding to a cloud desktop A may include: any one or more of a desktop roaming identifier representing that a user account logging in the cloud desktop A supports data roaming, a cache identifier, a capacity of a cache space of a service node, a clearing period of the cache space of the service node, or a preset clearing threshold. The configuration information corresponding to a cloud desktop B may include: a desktop roaming identifier representing that a user account logging in the cloud desktop B does not support data roaming. The configuration information described above is merely illustrative and may be updated according to the actual application scenario. Other types of configuration information not illustrated herein are also within the protection scope of the present application, and are not described in detail here.

Different types of configuration information can reflect functions of different types of cloud desktops, thereby ensuring better use experience when a user uses the different types of cloud desktops.

At operation S302, sending the configuration information to a service node.

After obtaining the configuration information, the service node will determine, according to the attribute information of the cloud desktop logged in by the terminal, whether to migrate user data, and when it is determined to migrate the user data, determine hotspot data according to access popularity corresponding to the user data, and migrate the hotspot data. Therefore, it is not necessary to migrate all the user data, which can reduce the migrated data volume, avoid high network bandwidth occupation in the process of data migration, and reduce the migration period.

In the cloud desktop data migration method provided in the present application, configuration information is generated according to acquired attribute information of a cloud desktop logged in by a terminal; so that different types of cloud desktops correspond to different types of configuration information, and the configuration information is sent to the service node so that the service node can reasonably plan and manage resources of the cloud desktops according to the different types of configuration information, determine, according to attribute information of a cloud desktop logged in by a terminal, whether to migrate user data, and when it is determined to migrate the user data, determine hotspot data according to access popularity corresponding to the user data, and migrate the hotspot data. Therefore, it is not necessary to migrate all the user data, which can reduce the migrated data volume, avoid high network bandwidth occupation in the process of data migration, and reduce the migration period.

A third aspect of the present application provides a service node. FIG. 4 shows a schematic structural diagram of a service node according to an embodiment of the present application. As shown in FIG. 4, the service node may include a first determination module 401, a second determination module 402, and a migration module 403.

The first determination module 401 is configured to determine, according to attribute information of a cloud desktop logged in by a terminal, whether to migrate user data, where the attribute information of the cloud desktop logged in by the terminal is information determined according to acquired configuration information of a management node. The second determination module 402 is configured to determine, when it is determined to migrate the user data, hotspot data according to access popularity corresponding to the user data. The migration module 403 is configured to migrate the hotspot data.

In the service node provided in the present application, the first determination module 401 determines, according to attribute information of the cloud desktop logged in by a terminal, whether to migrate user data, so as to ensure that the terminal can rapidly acquire the hotspot data; the second determination module 402 determines, when it is determined to migrate the user data, hotspot data according to access popularity corresponding to the user data; and the migration module 403 migrates the hotspot data. Therefore, it is not necessary to migrate all the user data, which can reduce the migrated data volume, avoid high network bandwidth occupation in the process of data migration, and reduce the migration period.

A fourth aspect of the present application provides a management node. FIG. 5 shows a schematic structural diagram of a management node according to an embodiment of the present application. As shown in FIG. 5, the management node may include a generation module 501 and a configuration module 502.

The generation module 501 is configured to generate configuration information according to acquired attribute information of a cloud desktop logged in by a terminal. The configuration module 502 is configured to send the configuration information to a service node so that the service node determines, according to attribute information of the cloud desktop logged in by a terminal, whether to migrate user data, and determines, when it is determined to migrate the user data, hotspot data according to access popularity corresponding to the user data, and migrates the hotspot data.

In the management node provided in the present application, the generation module 501 generates configuration information according to acquired attribute information of a cloud desktop logged in by a terminal, so that different types of cloud desktops correspond to different types of configuration information, and the configuration module 502 sends the configuration information to a service node so that the service node can reasonably plan and manage resources of the cloud desktops according to the different types of configuration information, determines, according to attribute information of the cloud desktop logged in by a terminal, whether to migrate user data, and determines, when it is determined to migrate the user data, hotspot data according to access popularity corresponding to the user data, and migrates the hotspot data. Therefore, it is not necessary to migrate all the user data, which can reduce the migrated data volume, avoid high network bandwidth occupation in the process of data migration, and reduce the migration period.

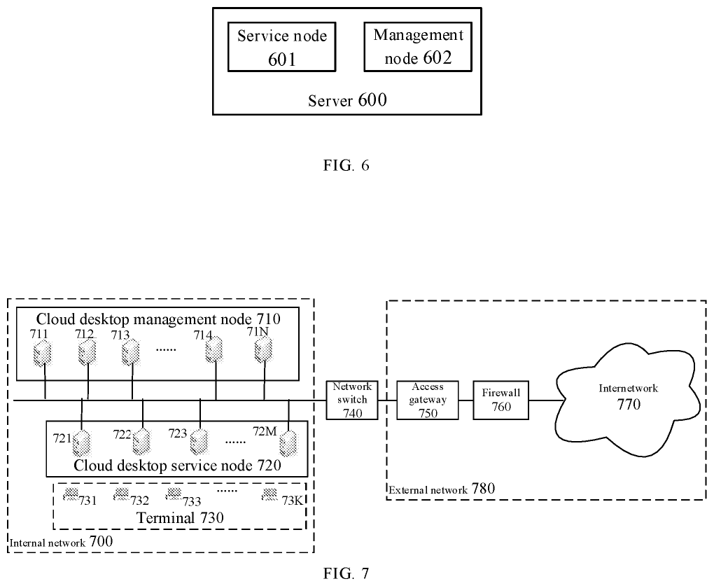

A fifth aspect of the present application provides a server. FIG. 6 shows a schematic structural diagram of a server according to an embodiment of the present application. As shown in FIG. 6, the server 600 may include both a service node 601 and a management node 602.

It should be noted that the server 600 may include only the service node 601; or the server 600 may include only the management node 602.

The service node 601 is configured to implement the cloud desktop data migration method according to the first aspect of the present application. The management node 602 is configured to implement the cloud desktop data migration method according to the second aspect of the present application.

The server 600 provided in the present application may include nodes with different functions. If the server includes only the service node 601, the server 600 may determine, according to attribute information of a cloud desktop logged in by a terminal, whether to migrate user data, so as to ensure that the terminal can rapidly acquire the hotspot data; and when it is determined to migrate the user data, determine hotspot data according to access popularity corresponding to the user data, and migrate the hotspot data. Therefore, it is not necessary to migrate all the user data, which can reduce the migrated data volume, avoid high network bandwidth occupation in the process of data migration, and reduce the migration period.

If the server 600 includes only the management node 602, the server 600 may generate configuration information according to acquired attribute information of a cloud desktop logged in by a terminal, so that different types of cloud desktops correspond to different types of configuration information, and send the configuration information to a service node so that the service node can reasonably plan and manage resources of the cloud desktops according to the different types of configuration information.

If the server 600 includes both the service node 601 and the management node 602, the server 600 may implement all functions of the two nodes, which ensures that a user can obtain the hotspot data determined according to the access popularity no matter what type of cloud desktop the user logs in. Therefore, it is not necessary to migrate all the user data, and the data migrated volume is reduced, while the migration period is shortened, and waste of network resources is avoided.

A sixth aspect of the present application provides a data migration system. FIG. 7 shows schematic network connection between devices in a data migration system according to an embodiment of the present application. As shown in FIG. 7, the data migration system includes an internal network 700, a network switch 740, and an external network 780.

The internal network 700 includes a cloud desktop management node 710, a cloud desktop service node 720, and a terminal 730. The cloud desktop management node 710 includes a plurality of service servers, for example, a service server 711, a service server 712, a service server 713, . . . , a service server 71N, and the like, where N is an integer greater than or equal to 1. The cloud desktop service node 720 includes a plurality of management servers, for example, a management server 721, a management server 722, a management server 723, . . . , a management server 71M, and the like, where M is an integer greater than or equal to 1. The terminal 730 includes a plurality of terminals, for example, a terminal 731, a terminal 732, a terminal 733, . . . , a terminal 73K, and the like, where K is an integer greater than or equal to 1. The external network 780 includes an access gateway 750, a firewall 760, and an internetwork 770.

A user may access different cloud desktops through the respective terminals, and then accesses an intranet or extranet device through the cloud desktops. If a company establishes a plurality of branches at different places which perform mutual information interaction, data center nodes may be established at the places of the branches, where each data center node is an internal network 700, thereby implementing intranet interconnection among multiple data center nodes across regions or cities.

Network devices such as the network switch 740, the access gateway 750, and the firewall 760 are connected to other data center nodes through the internetwork 770, to implement network connection among multiple data center nodes.

Through the internal network interconnection among the data center nodes, each data center node can provide cloud desktop resources and cloud computing services for a user to satisfy the requirement of accessing a nearby cloud desktop by the user. Therefore, the cloud desktop resources of the multiple data center nodes can be uniformly managed and scheduled, the access efficiency of the user is increased, and the cost of renting bandwidth by enterprises is reduced.

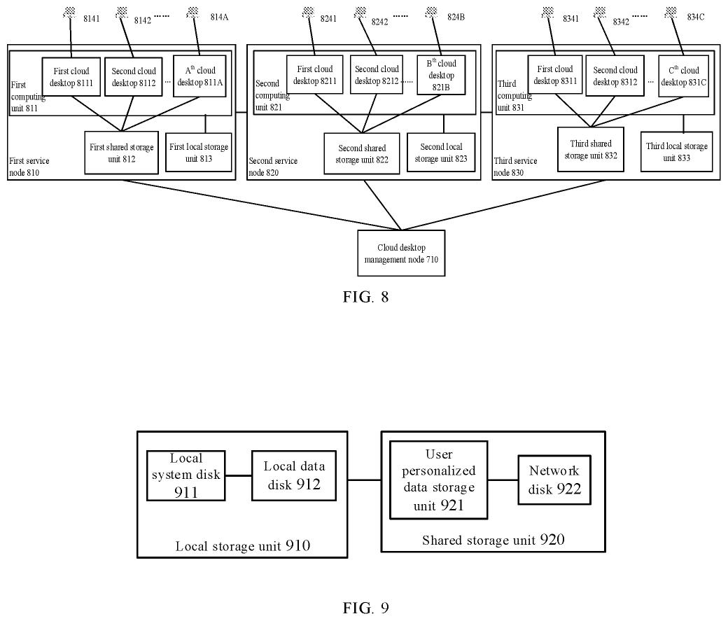

FIG. 8 shows a schematic structural diagram of modules in a data migration system according to an embodiment of the present application. As shown in FIG. 8, the data migration system includes a cloud desktop management node 710, a plurality of terminals, and a plurality of service nodes (e.g., a first service node 810, a second service node 820, a third service node 830, etc.). The data migration system may include a plurality of service nodes, but FIG. 8 merely illustrates 3 service nodes by way of example, and the cloud desktop management node 710 may manage more service nodes according to the processing performance of the cloud desktop management node 710.

The cloud desktop management node 710 is configured to perform unified management on the cloud desktop service nodes, and may have the functions of: resource management, user management, terminal management, system management, authentication management, roaming management, and the like.

The resource management function is used for managing any one or more resources of a data center, a resource pool, computing resources, storage resources, network resources or cloud desktop resources. The user management function is used for managing user information, for example, adding, modifying, deleting, inquiring a registered user account of the cloud desktop, and the like; or further for confirming whether a certain registered user account supports roaming of personalized data, confirming whether the registered user account supports access to a network disk, and the like. The terminal management function is used for maintaining terminal information, for example, binding a certain terminal with a registered user account, or upgrading a certain registered user account, and the like. The system management function is used for managing system configuration information, authority of a registered user account, log files, monitoring alarm information, system performance statistical information, and the like. The authentication management function is used for authenticating a user account accessing the cloud desktop, for example, authenticating a user account locally, authenticating a user account by a third party device, authenticating a user account uniformly by multiple party devices, and the like. The roaming management function is used for counting access popularity of the user data, managing configuration information corresponding to the second type cloud desktop, and the like. A service node where the second type cloud desktop is logged in is a roaming service node, which is located at a different geographical location from a home service node.

For example, configuration information of cloud desktop management node 710 may include: any one or more of a desktop roaming identifier, a storage address, a migrated volume of the user data, a cache identifier, a capacity of a cache space of a service node, a clearing period of the cache space of the service node, or a preset clearing threshold.

The desktop roaming identifier represents whether a user account logging in the cloud desktop supports data roaming (for example, whether supports roaming of user personalized data stored in a system disk, whether supports accessing data stored in a network disk, or the like), and the cache identifier represents whether to cache the updated user data, and the capacity of the cache space of the service node is larger than or equal to the migrated volume of the user data. The migration of the user data may include migrating the user data by automatically downloading hotspot data from a storage unit, and the cloud desktop management node 710 may further set a volume of the automatically downloaded data. The preset clearing threshold may be a time threshold (for example, data in the cache space is cleared every 1 hour, 10 hours, 12 hours, or 24 hours, etc.), or may be determined based on a storage capacity threshold (e.g., in the form of a percentage) (for example, the cache space is cleared when data stored in the cache space occupies more than 80% of the capacity of the cache space).

Each service node includes a computing unit, a shared storage unit, and a local storage unit. For example, the first service node 810 includes: a first computing unit 811, a first shared storage unit 812, and a first local storage unit 813. The first computing unit 811 includes: a first cloud desktop 8111, a second cloud desktop 8112, . . . , and an A^{th} cloud desktop 811A, where A is an integer greater than or equal to 1. The second service node 820 includes: a second computing unit 821, a second shared storage unit 822, and a second local storage unit 823. The second computing unit 821 includes: a first cloud desktop 8211, a second cloud desktop 8212, . . . , and a B^{th} cloud desktop 821B, where B is an integer greater than or equal to 1. The third service node 830 includes: a third computing unit 831, a third shared storage unit 832, and a third local storage unit 833. The third computing unit 831 includes: a first cloud desktop 8311, a second cloud desktop 8312, . . . , and a C^{th} cloud desktop 831C, where C is an integer greater than or equal to 1. Each cloud desktop in FIG. 8 is a cloud desktop virtual machine, and may provide cloud desktop services for different terminals.

For example, the first computing unit 811 is configured to record access time and accessed byte sizes of user data in the first cloud desktop 8111, the second cloud desktop 8112, . . . , and the A^{th} cloud desktop 811A, generate a record file corresponding to each cloud desktop, and report the record file to the cloud desktop management node 710.

Each cloud desktop can access the shared storage unit in the corresponding service node, but has its own local storage unit 813. For example, each of the first cloud desktop 8111, the second cloud desktop 8112, . . . , and the A^{th} cloud desktop 811A can access the first shared storage unit 812, and a partial local storage area is allocated in the first local storage unit 813 for each of the first cloud desktop 8111, the second cloud desktop 8112, . . . , and the A^{th} cloud desktop 811A, so that each cloud desktop can locally cache user data.

Each service node provides cloud desktop services for a plurality of corresponding terminals. For example, the first service node 810 provides cloud desktop services for the terminal 8141, the terminal 8142, . . . , the terminal 814A, and the like; the second service node 820 provides cloud desktop services for the terminal 8241, the terminal 8242, . . . , the terminal 824B, and the like; and the third service node 830 provides cloud desktop services for the terminal 8341, the terminal 8342, . . . , the terminal 834C, and the like. Types of terminals may include: any one or more of a customized small cloud terminal, a personal computer (PC), a laptop, a smart phone, or a tablet computer (Pad).

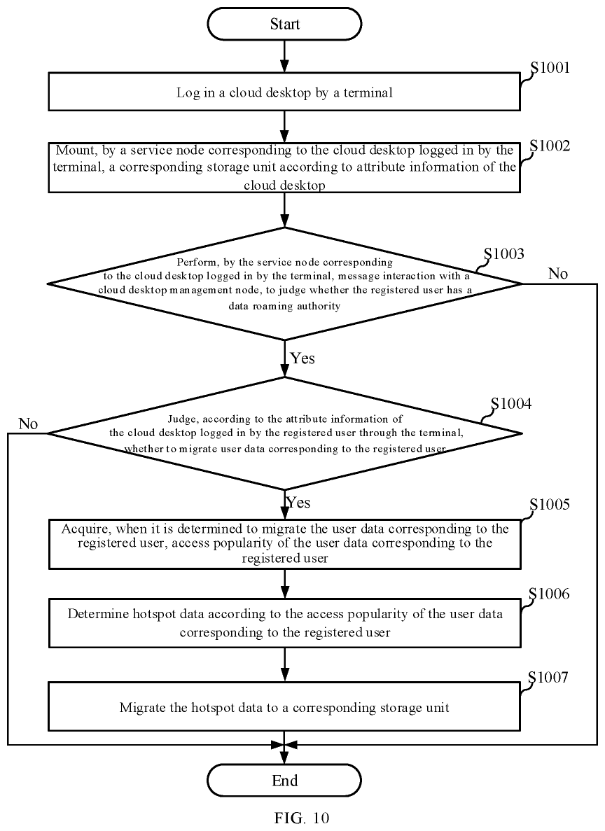

FIG. 9 shows a schematic structural diagram of a storage unit according to an embodiment of the present application. As shown in FIG. 9, the storage unit includes a local storage unit 910 and a shared storage unit 920.

The local storage unit 910 includes a local system disk 911 and a local data disk 912. The shared storage unit 920 includes: a user personalized data storage unit 921, and a network disk 922. The user personalized data storage unit 921 may be configured to store user specific data, such as my documents, favorites, my downloads, desktop profiles, and the like.

Through configuration and management by the cloud desktop management node 710, storage resources of the local storage unit 910 are allocated to the respective cloud desktops for use, so that each cloud desktop has an exclusive share of the storage space in the local storage unit 910. The local storage unit 910 includes: any one or more of a redundant array of independent disks (RAID), a distributed file storage server or a hard disk.

After a user logs in any cloud desktop by a terminal, the user data in the user personalized data storage unit 921 in the shared storage unit 920 can be provided to the user by means of an automatic mounting storage unit in the cloud desktop, so that the user can perform a data read/write operation. For example, the first computing unit 811 stores system data in the local system disk 911 of the cloud desktop, and stores local data of the user in the local data disk 912. The user personalized data is then stored in the user personalized data storage unit 921, and shared network data that can be accessed by other users is stored in the network disk 922. The shared storage unit 920 may include: any one or more of a network attached storage (NAS) device, a distributed file storage server, or a cloud disk. The shared storage unit 920 is directly connected to the respective cloud desktops, to increase an access speed of each cloud desktop to the shared storage unit 920.

It should be noted that the NAS device is a dedicated data storage server which takes data as a center, completely separates the storage device from the server, and performs centralized management on the data, thereby reducing the dependence on network bandwidth and improving the storage performance, while reducing the maintenance cost.

In some implementations, the data migration system shown in FIG. 8 may include the following three application scenarios.

1) A first type cloud desktop application scenario in which: a registered user logs in the first cloud desktop 8111 by the terminal 8141, to obtain user data corresponding to the first cloud desktop 8111. A service node of the home location corresponding to a user account logging in the first type cloud desktop is a home service node.

The first cloud desktop 8111 may store the user data corresponding to the registered user in storage space corresponding to the terminal 8141 in the first local storage unit 813, or in the first shared storage unit 812, where in the first shared storage unit 812, each cloud desktop in the first computing unit 811 has an exclusive shared storage directory corresponding to the registered user.

For example, a first type cloud desktop for a first registered user UserA is the first cloud desktop 8111, and the first registered user UserA may log in the first cloud desktop 8111 by the terminal 8141. It should be noted that the first registered user UserA may be bond or not bond to the terminal 8141. The first shared storage unit 812 includes a shared storage directory corresponding to the first registered user UserA, and the first registered user UserA can access user data in the shared storage directory corresponding to UserA in the first shared storage unit 812 by logging in different cloud desktops to, for example, perform a read/write operation on the user data.

2) A shared cloud desktop application scenario in which: the attribute information of the cloud desktop logged in by the first registered user UserA is a shared cloud desktop, i.e., a desktop that can be logged in by any registered user, and in the case of determining that the first registered user UserA has logged out of the shared cloud desktop, the first computing unit 811 may recycle resources of the shared cloud desktop so that the shared cloud desktop can provide cloud services for other registered users.

For example, when the first registered user UserA logs in the second cloud desktop 8112 by the terminal 8142, the second cloud desktop 8112 will automatically mount user data in the shared storage directory corresponding to the first registered user UserA in the first shared storage unit 812, so that the first registered user UserA can further use the user data stored last time.

3) A second type cloud desktop application scenario in which: when the first registered user UserA logs in the first cloud desktop 8211 in the second service node 820 due to work needs, but the second service node 820 and the first service node 810 are not located in the same geographical location (for example, the second service node 820 is in Shanghai, while the first service node 810 is in Beijing, or the like), the first cloud desktop 8211 in the second service node 820 can still mount the user data in the shared storage directory corresponding to the first registered user UserA in the shared storage unit 812 of the first service node 810 according to the desktop roaming identifier of the first registered user UserA and attribute information (i.e., second type cloud desktop) of the cloud desktop logged in by the first registered user UserA, so as to ensure that the first registered user can access the stored user data smoothly.

A service node where the second type cloud desktop is logged in is a roaming service node, which is located at a different geographical location from a home service node.

The attribute information of different cloud desktops enables a user to access the user data stored in the shared storage unit corresponding to the home location smoothly, thereby bringing about high-quality use experience to the user.

The following describes in detail a hotspot data processing method at each service node with reference to the accompanying drawings. FIG. 10 is a schematic flowchart of a method for migrating hotspot data by a service node according to an embodiment of the present application. As shown in FIG. 10, the method includes the following operations S1001 to S1007.

At operation S1001, logging in a cloud desktop by a terminal.

The cloud desktop may be a second type cloud desktop or a shared cloud desktop. The second type cloud desktop and the shared cloud desktop are both cloud desktops of service nodes located at different geographical locations from the home service node of the terminal. For example, if the first service node 810 is in Beijing while the second service node 820 is in Shanghai, the cloud desktop corresponds to the second type cloud desktop; and if the first service node 810 is in Haidian district of Beijing while the second service node 820 is in Dongcheng district of Beijing, the cloud desktop corresponds to the shared cloud desktop.

For example, if a registered user is bound to the terminal 8141 in the first service node 810, the first type cloud desktop of the registered user is the first cloud desktop 8111 corresponding to the terminal 8141. The first service node 810 and the second service node 820 are two service nodes respectively located at different geographical locations, and the service node corresponding to the home location of the terminal 8141 is the first service node 810. If the registered user logs in the second cloud desktop 8112 in the first service node 810 by the terminal 8142, the second cloud desktop 8112 is referred to as a shared cloud desktop of the registered user; and if the registered user logs in the second cloud desktop 8212 in the second service node 820 by the terminal 8242, the second cloud desktop 8212 is referred to as a second type cloud desktop of the registered user.

At operation S1002, mounting, by a service node corresponding to the cloud desktop logged in by the terminal, a corresponding storage unit according to attribute information of the cloud desktop.

For example, if the registered user logs in the second cloud desktop 8112 in the first service node 810 by the terminal 8142, the first computing unit 811 corresponding to the second cloud desktop 8112 will mount a storage unit corresponding to the registered user. For example, if the service node corresponding to the home location of the terminal 8141 bound by the registered user is the first service node 810, the first computing unit 811 will mount a shared storage address corresponding to the registered user in the first shared storage unit 812.

At operation S1003, performing, by the service node corresponding to the cloud desktop logged in by the terminal, message interaction with a cloud desktop management node, to judge whether the registered user has a data roaming authority.

For example, if the registered user logs in the second cloud desktop 8112 in the first service node 810 by the terminal 8142, the first computing unit 811 corresponding to the second cloud desktop 8112 performs message interaction with the cloud desktop management node 710, to judge whether the registered user has a data roaming authority.

In the case of determining that the registered user has the data roaming authority, operation S1004 is performed; otherwise, the flow is ended.

At operation S1004, judging, according to the attribute information of the cloud desktop logged in by the registered user through the terminal, whether to migrate user data corresponding to the registered user.

It should be noted that if the type of the cloud desktop in the attribute information of the cloud desktop logged in by the terminal is determined to be the shared cloud desktop or the second type cloud desktop, the user data corresponding to the registered user is desired to be migrated, and operation S1005 is performed; otherwise, if the type of the cloud desktop in the attribute information of the cloud desktop logged in by the terminal is determined to be the first type cloud desktop bound with the registered user, the user data corresponding to the registered user is not to be migrated, so that the registered user simply acquires the user data corresponding to the registered user from the corresponding local storage unit, and then the flow is ended.

At operation S1005, acquiring, when it is determined to migrate the user data corresponding to the registered user, access popularity of the user data corresponding to the registered user.

The user data includes: a plurality of files to be processed. The access popularity of the user data may be determined by:
acquiring access information corresponding to each file to be processed, where the access information corresponding to each file to be processed includes: any one or more of a data type of the file to be processed, time information of the file to be processed, access path information of the file to be processed, or a data volume of the file to be processed; and
determining, according to the access information corresponding to each file to be processed, a popularity value of each file to be processed. For example, the method may include: acquiring current time; determining a time weight according to the historical access time of the file to be processed and the current time; and determining a popularity value of the file to be processed according to the time weight and the data volume of the file to be processed.

It should be noted that if a certain file to be processed is accessed m times within n days, where n and m are both integers greater than or equal to 1, the number of bytes of the file to be processed accessed each time and a time weight Wx may be multiplied, and multiplication results of the m times may be accumulated to obtain a popularity value of the file to be processed. For example, the popularity value k of the file to be processed may be calculated by equation (1):

$$k = {\sum }_{1}^{m} ( Mi * Wx ) \qquad ( 1 )$$

where Mi represents the number of bytes of the file to be processed accessed at an i^{th} time, is an integer greater than or equal to 1 and less than or equal to m, Wx represents the time weight, and x represents a difference between the historical access time of the file to be processed and the current time, which is in a range of 0 to (n−1), where n is an integer greater than 1, and m is an integer greater than or equal to 1. The time weight Wx may be set according to the actual situation.

In some implementations, a weight of the data type corresponding to the file to be processed may also be determined according to a data type of the file to be processed; and a popularity value of the file to be processed may be determined according to the weight of the data type, the data volume of the file to be processed, a time weight in the time information of the file to be processed, and a path weight in the access path information of the file to be processed.

For example, the popularity value k of the file to be processed may be calculated by equation (2):

$$k = {\sum }_{1}^{n u m} ( W\_Type \_x * W\_Time \_y * W\_Path \_z * W\_Size \_i ) \qquad ( 2 )$$

where W_Type_x represents a weight of a data type, W_Time_y represents a time weight, W_Path_z represents a path weight of an access path; W_Size_i represents a data volume of the file to be processed, and num represents that the file is accessed num times within n days, where n is an integer greater than or equal to 1.

For example, weights of m data types are set, and each data type may have a weight represented as W_Type_x, where x is an integer greater than or equal to 1 and less than or equal to m, and m is an integer greater than or equal to 1. For example, W_Type_0 is set to be a weight of a default data type, e.g., W_Type_0 is set to 0.1; W_Type_1 is set to represent a weight of the data type of text file, where for example, for any one or more of text file types such as word, excel, ppt, pdf, txt and the like, W_Type_1 is set to 1; W_Type_2 is set to represent a weight of the data type of email, where for example, W_Type_2 may be set to 1; W_Type_3 is set to represent a weight of an image or picture file, where for example, W_Type_3 may be set to 0.8; and W_Type_4 is set to represent a weight of a video file, where for example, W_Type_4 may be set to 0.5.

The weights of different data types can reflect importance degrees of the data types, so that important files can be preferentially accessed, and the access efficiency of data is improved.

For example, the access popularity of each file to be processed in the last n days is counted, where n is an integer greater than or equal to 1. Let y be a difference (e.g., number of days) between the historical access time and the current time, and the time weight is W_Time_y, where y is an integer greater than or equal to 0 and less than or equal to n−1. For example, assuming that n is equal to 7, when the difference between the historical access time and the current time is 0 (i.e., when y is 0), the file to be processed has a maximum time weight W_Time_0, i.e., 1; when the difference between the historical access time and the current time is 1 (i.e., when y is 1), the file to be processed has a time weight W_Time_1= 6/7; and when the difference between the historical access time and the current time is y, the file to be processed has a time weight W_Time_y=(7−y)/7.

The above unit of n or y is merely illustrative, and for example, the access popularity of each file to be processed in the last n hours may be counted when needed, in which case y may be the number of hours.

The time weight can reflect the frequency of data access, so that data more frequently accessed can be obtained.

For example, the path weight may be set as follows: for example, path weights of z access paths are set to W_Path_z, respectively, where z is an integer greater than or equal to 1. For example, if an access path 1 is a path corresponding to a system file (e.g., the access path C:/windows, or the like), a path weight W_Path_1 of the access path 1 may be set to 0; and if an access path 2 is not a system file (e.g., D:/w/zy/er, or the like), a path weight W_Path_2 of the access path 2 may be set to 1.

It should be noted that when the path weight is determined to be 1, it indicates that all files in the access path are counted, and when the path weight is determined to be 0, it indicates that none of the files in the access path are counted. In other words, the system file corresponding to the access path with the path weight 0 should be filtered out, so as to avoid statistical errors caused by too many system files, and improve the accuracy of the file popularity value.

At operation S1006, determining hotspot data according to the access popularity of the user data corresponding to the registered user.

For example, the plurality of files to be processed may be ranked according to the popularity value of each file to be processed calculated in operation S1005, to obtain a ranking result; and the hotspot data is screened from the plurality of files to be processed based on the ranking result.

At operation S1007, migrating the hotspot data to a corresponding storage unit.

According to the access popularity corresponding to the hotspot data, hotspot data with the highest access popularity is preferentially migrated. Then, the migrated hotspot data is provided to a registered user, so that the registered user can process the hotspot data through a terminal.

For example, in a case of determining that the terminal logs in a shared cloud desktop, the hotspot data corresponding to the registered user logged in by the terminal and stored in the shared storage unit may be migrated to a storage address of a local storage unit for the registered user at the home location of the registered user. In a case of determining that the terminal logs in a second type cloud desktop, the hotspot data corresponding to the registered user logged in by the terminal and stored in the shared storage unit corresponding to the home service node is migrated to a storage address of the storage unit corresponding to the roaming service node.

Meanwhile, the access popularity corresponding to the hotspot data is accumulated to update the access information of the hotspot data in time.

In this embodiment, a corresponding storage unit is mounted through the second type cloud desktop or shared cloud desktop logged in by the terminal, and message interaction is performed between a cloud desktop service node and a cloud desktop management node to judge whether the registered user has a data roaming authority. In the case of determining that the registered user has the data roaming authority, it is judged whether to migrate user data corresponding to the registered user according to the attribute information of the cloud desktop logged in by the registered user through the terminal, so as to ensure that the terminal can rapidly acquire the desired user data. When it is determined to migrate the user data, hotspot data is determined according to access popularity corresponding to the user data and migrated to a corresponding storage unit. Therefore, instead of migrating all the user data, only the hotspot data is migrated, which can reduce the migrated data volume, avoid high network bandwidth occupation in the process of data migration, and reduce the migration period.

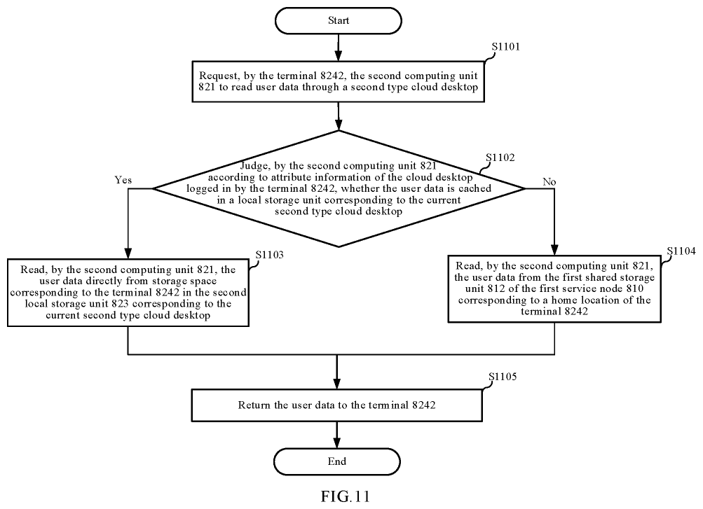

FIG. 11 is a schematic flowchart of a method for reading user data by a terminal through a second type cloud desktop according to an embodiment of the present application. As shown in FIG. 11, The method includes the following operations S1101 to S1105.

At operation S1101, requesting, by the terminal 8242, the second computing unit 821 to read user data through a second type cloud desktop.

The user data includes multiple pieces of hotspot data with different degrees of access popularity, and the terminal 8242 may request the second computing unit 821 to read the hotspot data in the user data through a second type cloud desktop to increase a reading speed of the user data.

At operation S1102, judging, by the second computing unit 821 according to attribute information (i.e., second type cloud desktop) of the cloud desktop logged in by the terminal 8242, whether the user data is cached in a local storage unit corresponding to the current second type cloud desktop.

For example, in the case of determining that the user data is cached in the second local storage unit 823 corresponding to the current second type cloud desktop, operation S1103 is performed; otherwise, in the case of determining that the user data is not cached in the second local storage unit 823 corresponding to the current second type cloud desktop, operation S1104 is performed.

At operation S1103, reading, by the second computing unit 821, the user data directly from storage space corresponding to the terminal 8242 in the second local storage unit 823 corresponding to the current second type cloud desktop.

At operation S1104, reading, by the second computing unit 821, the user data from the first shared storage unit 812 of the first service node 810 corresponding to a home location of the terminal 8242.

At operation S1105, returning the user data to the terminal 8242.

In this embodiment, the cloud desktop service node judges, based on the fact that the terminal logs in a second type cloud desktop, whether the user data is cached in the local storage unit corresponding to the current second type cloud desktop, and reads the user data from different storage units according to the judgment result, so that the terminal can rapidly obtain the user data, and the user experience can be improved.

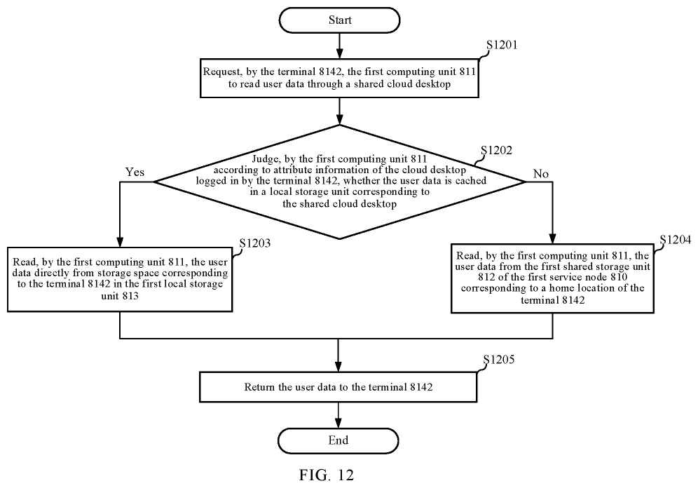

FIG. 12 is a schematic flowchart of a method for reading user data by a terminal through a shared cloud desktop according to an embodiment of the present application. As shown in FIG. 12, the method includes the following operations S1201 to S1205.

At operation S1201, requesting, by the terminal 8142, the first computing unit 811 to read user data through a shared cloud desktop.

The user data includes a plurality of files to be processed, and the plurality of files to be processed may be ranked according to the access popularity of each file to be processed, so as to obtain hotspot data with higher access popularity.

The terminal 8142 may request the first computing unit 811 to read part of the hotspot data in the user data through the shared cloud desktop, so as to increase a reading speed of the user data.

At operation S1202, judging, by the first computing unit 811 according to attribute information (i.e., shared cloud desktop) of the cloud desktop logged in by the terminal 8142, whether the user data is cached in a local storage unit corresponding to the shared cloud desktop.

For example, in the case of determining that the user data is cached in the first local storage unit 813 corresponding to the shared cloud desktop, operation S1203 is performed; otherwise, in the case of determining that the user data is not cached in the first local storage unit 813, operation S1204 is performed.

At operation S1203, reading, by the first computing unit 811, the user data directly from storage space corresponding to the terminal 8142 in the first local storage unit 813.

At operation S1204, reading, by the first computing unit 811, the user data from the first shared storage unit 812 of the first service node 810 corresponding to a home location of the terminal 8142.

At operation S1205, returning the user data to the terminal 8142.

In this embodiment, the cloud desktop service node judges, based on the fact that the terminal logs in a shared cloud desktop, whether the user data is cached in the local storage unit corresponding to the shared cloud desktop, and reads the user data from the first local storage unit or the first shared storage unit of the first service node, so that the terminal can rapidly obtain the user data, and the user experience can be improved.

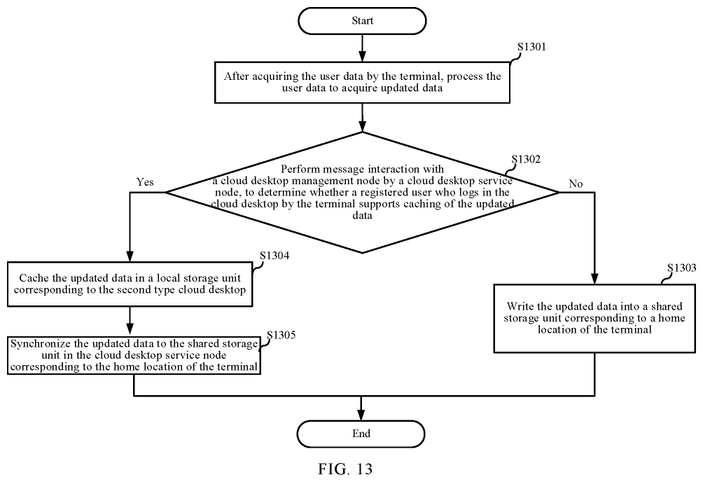

FIG. 13 is a schematic flowchart of a method for writing hotspot data by a terminal through a second type cloud desktop according to an embodiment of the present application. As shown in FIG. 13, the method includes the following operations S1301 to S1303.

At operation S1301, after acquiring the user data by the terminal, processing the user data to acquire updated data.

At operation S1302, performing message interaction with a cloud desktop management node by a cloud desktop service node, to determine whether a registered user who logs in the cloud desktop by the terminal supports caching of the updated data.

For example, the cloud desktop service node determines whether to cache the updated data according to a cache identifier sent from the cloud desktop management node. The cache identifier represents whether to cache the updated user data.

In the case of determining that the registered user who logs in the cloud desktop by the terminal does not support caching of the updated data, operation S1303 is performed, and the flow is ended; and in the case of determining that the registered user who logs in the cloud desktop by the terminal supports caching of the updated data, operation S1304 is performed.

At operation S1303, writing the updated data into a shared storage unit corresponding to a home location of the terminal.

For example, the updated data is written into the first shared storage unit 812 of the first service node 810 corresponding to the home location of the terminal 8242.

At operation S1304, caching the updated data in a local storage unit in the service node corresponding to the second type cloud desktop.

For example, if the terminal 8242 logs in a second type cloud desktop (e.g., the second cloud desktop 8212 in the second service node 820), the updated data of the terminal 8242 is cached in storage space corresponding to the terminal 8242 in the second local storage unit 823. Then, access popularity corresponding to the updated data is accumulated according to access information corresponding to the updated data; and the updated data and the corresponding access popularity are cached in storage space corresponding to the terminal 8242 in the second local storage unit 823.

The access popularity may be determined according to any one or more of historical access time of the updated data, an access frequency of the updated data within a preset time period, a data type of the updated data, or a data volume of the updated data.

At operation S1305, synchronizing the updated data to the shared storage unit in the cloud desktop service node corresponding to the home location of the terminal.

The synchronization of the updated data may be implemented by an asynchronous synchronization operation in a processing queue mode, so as to increase the processing efficiency of the data.

In this embodiment, the cloud desktop service node performs interaction with the cloud desktop management node to determine whether a registered user who logs in the cloud desktop by the terminal supports caching of the updated data, and then, the updated data is cached to different storage units according to a determination result for easy use by a registered user, and synchronized to the shared storage unit in the cloud desktop service node corresponding to the home location of the terminal, so that the user data stored in the shared storage unit corresponding to the home service node can be updated in time, and the accuracy of the data is improved.

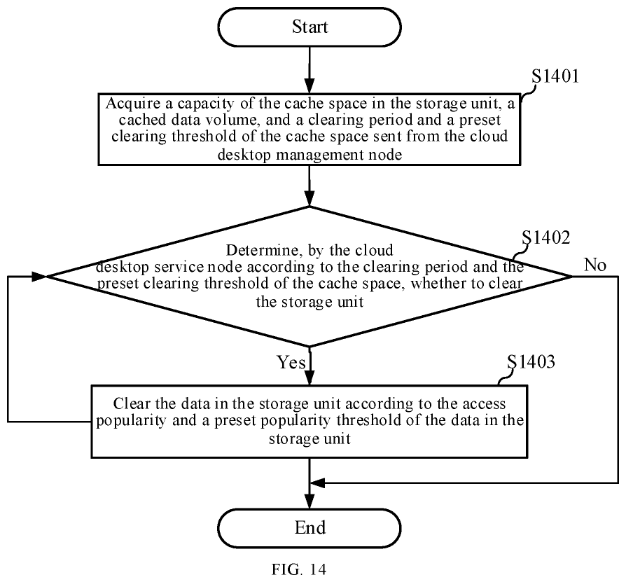

FIG. 14 is a schematic flowchart of a method for clearing a storage unit corresponding to a second type cloud desktop according to an embodiment of the present application. As shown in FIG. 14, the method includes the following operations S1401 to S1403. At operation S1401, acquiring a capacity of the cache space in the storage unit, a cached data volume, and a clearing period and a preset clearing threshold of the cache space sent from the cloud desktop management node.

The storage unit may be a local storage unit corresponding to the second type cloud desktop of the terminal.

For example, if the terminal 8242 logs in a second type cloud desktop (e.g., the second cloud desktop 8212 in the second service node 820), then the storage unit is the storage space corresponding to the terminal 8242 in the second local storage unit 823 corresponding to the second type cloud desktop.

At operation S1402, determining, by the cloud desktop service node according to the clearing period and the preset clearing threshold of the cache space, whether to clear the storage unit.

In some implementations, a cache proportion is determined according to the capacity of the cache space in the storage unit and the cached data volume, and then it is determined, according to the cache proportion and a preset clearing threshold (e.g., 80%), whether to clear data in the cache space of the storage unit. If the cache proportion reaches 80%, it indicates that data in the cache space of the storage unit needs to be cleared; and if the cache proportion is less than 80%, the data in the cache space of the storage unit is not cleared.

In some implementations, whether to clear the data in the cache space of the storage unit may be determined by determining whether the clearing period (e.g., 8 hours) of the cache space is reached based on the time information. If a difference between the current time and the last time for clearing the storage unit exceeds 8 hours, it is determined that the data in the cache space of the storage unit needs to be cleared; otherwise, the data in the cache space of the storage unit is not cleared.

In the case of determining that the data in the cache space of the storage unit needs to be cleared, operation S1403 is performed; otherwise, the flow is ended.

At operation S1403, clearing the data in the storage unit according to the access popularity and a preset popularity threshold of the data in the storage unit.

The data in the storage unit may be ranked according to the access popularity, data with the access popularity less than a preset popularity threshold (e.g., 0.5) and ranked lower is obtained and used as data to be cleared, which is then deleted to save the storage space.

It should be noted that operations S1402 and S1403 may be repeatedly executed until the storage unit satisfies the storage requirement. For example, the clearing of the storage unit may be stopped when the cache proportion drops to 50%.

In an implementation, in the case of determining that the registered user has logged out of the second type cloud desktop, the cache data of the registered user in the local storage unit corresponding to the second type cloud desktop is cleared only after determining that the cloud desktop service node has synchronized the updated data of the registered user to the shared storage unit corresponding to the home service node of the terminal to which the registered user is bound, so as to avoid loss of the updated data and ensure safety of the data.

In this embodiment, the cloud desktop service node determines whether to clear the storage unit according to the clearing period and the preset clearing threshold of the cache space, to guarantee available storage space in the storage unit; and in the case of determining to clear the data in the storage unit, the data in the storage unit is cleared according to the access popularity and the preset popularity threshold of the data in the storage unit, so as to ensure more cache space for the timely updated data, avoid loss of the updated data, and improve the accuracy of the data.

It should be noted that the present application is not limited to the specific configurations and processing described in the embodiments and shown in the figures. For convenience and simplicity of description, detailed description of a known method is omitted here, and for the specific working processes of the system, the modules and the units described above, reference may be made to corresponding processes described above, which are not repeated here.

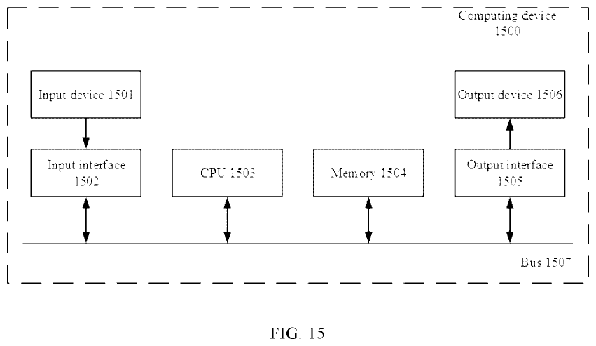

FIG. 15 is a block diagram showing an exemplary hardware architecture of a computing device capable of implementing the cloud desktop data migration method and apparatus according to an embodiment of the present application.

As shown in FIG. 15, the computing device 1500 includes an input device 1501, an input interface 1502, a central processing unit 1503, a memory 1504, an output interface 1505, and an output device 1506. The input interface 1502, the central processing unit 1503, the memory 1504, and the output interface 1505 are connected to each other via a bus 1507, and the input device 1501 and the output device 1506 are connected to the bus 1507 via the input interface 1502 and the output interface 1505, respectively, and further connected to other components of the computing device 1500.

The input device 1501 receives input information from the outside, and transmits the input information to the central processing unit 1503 through the input interface 1502; the central processing unit 1503 processes the input information based on computer-executable instructions stored in the memory 1504 to generate output information, stores the output information temporarily or permanently on the memory 1504, and then transmits the output information to the output device 1506 through the output interface 1505; and the output device 1506 outputs output information outside of the computing device 1500 for use by a user.

In some implementations, the computing device shown in FIG. 15 may be implemented as an electronic device, including: a memory configured to store a computer program; and a processor configured to execute the computer program stored on the memory to implement the cloud desktop data migration method according to any of the above embodiments.

In some implementations, the computing device shown in FIG. 15 may be implemented as a data migration system, including: a memory configured to store a computer program; and a processor configured to execute the computer program stored on the memory to implement the cloud desktop data migration method according to any of the above embodiments.

An embodiment of the present application further provides a computer-readable storage medium having a computer program stored thereon which, when executed by a processor, causes the cloud desktop data migration method according to any of the above embodiments to be implemented.

The above are merely exemplary embodiments of the present application and not intended to limit the scope of the present application. In general, the various embodiments of the present application may be implemented in hardware or special purpose circuits, software, logic or any combination thereof. For example, some aspects may be implemented in hardware, while other aspects may be implemented in firmware or software which may be executed by a controller, a microprocessor or any other computing device, although the present application is not limited thereto.

Embodiments of the present application may be implemented by a data processor of a mobile device executing computer program instructions, for example, in a processor entity, or by hardware, or by a combination of software and hardware. The computer program instructions may be assembler instructions, instruction set architecture (ISA) instructions, machine instructions, machine-related instructions, microcodes, firmware instructions, state setting data, or source or object codes written in any combination of one or more programming languages.

The block diagrams of any logic flow in the figures of the present application may represent program operations, or may represent interconnected logic circuits, modules, and functions, or may represent a combination of program operations and logic circuits, modules, and functions. The computer program may be stored on a memory. The memory may be of any type suitable to the local technical environment and may be implemented in any suitable data storage technology, such as but not limited to, read only memories (ROMs), random access memories (RAMs), optical storage devices or systems (digital versatile discs (DVDs), compact discs (CDs)), etc. The computer-readable medium may include a non-transitory storage medium. The data processor may be of any type suitable to the local technical environment, such as but not limited to, general purpose computers, dedicated computers, microprocessors, digital signal processors (DSPs), application specific integrated circuits (ASICs), field programmable gate arrays (FGPAs), and processors based on multi-core processor architecture.

The foregoing has provided by way of exemplary and non-limiting examples a detailed description of exemplary embodiments of the present application. Various modifications and adaptations to the foregoing embodiments may become apparent to those skilled in the art in view of the accompanying drawings and the appended claims, without departing from the scope of the present application. Accordingly, the proper scope of the present application is to be determined according to the claims.

1. A cloud desktop data migration method, comprising:
determining, according to attribute information of a cloud desktop logged in by a terminal, whether to migrate user data, wherein the attribute information of the cloud desktop logged in by the terminal is information determined according to acquired configuration information of a management node;
determining, when it is determined to migrate the user data, hotspot data according to access popularity corresponding to the user data; and
migrating the hotspot data.

2. The method according to claim 1, wherein the user data comprises: a plurality of files to be processed;
determining, when it is determined to migrate the user data, hotspot data according to access popularity corresponding to the user data comprises:
acquiring, when it is determined to migrate the user data, access information corresponding to each file to be processed;
determining, according to the access information corresponding to each file to be processed, a popularity value of each file to be processed;
ranking the plurality of files to be processed according to the popularity value of each file to be processed to obtain a ranking result; and
screening, based on the ranking result, the plurality of files to be processed to obtain the hotspot data.

3. The method according to claim 2, wherein the access information corresponding to each file to be processed comprises: any one or more of a data type of the file to be processed, time information of the file to be processed, access path information of the file to be processed, or a data volume of the file to be processed.

4. The method according to claim 3, wherein the time information of the file to be processed comprises: historical access time of the file to be processed; and
determining, according to the access information corresponding to each file to be processed, the popularity value of each file to be processed comprises:
acquiring current time;
determining a time weight according to the historical access time of the file to be processed and the current time; and
determining a popularity value of the file to be processed according to the time weight and the data volume of the file to be processed,
or,
wherein determining, according to the access information corresponding to each file to be processed, the popularity value of each file to be processed comprises: determining, according to the data type of the file to be processed, a weight of the data type corresponding to the file to be processed; and determining a popularity value of the file to be processed according to the weight of the data type, the data volume of the file to be processed, a time weight in the time information of the file to be processed, and a path weight in the access path information of the file to be processed.

5. (canceled)

6. The method according to claim 1, wherein the cloud desktop data migration method is applied to a service node comprising: a home service node, or the home service node and a roaming service node, wherein the home service node is a service node for a user account at a home location, and the roaming service node is a service node for the user account at a roaming location; and
the cloud desktop data migration method further comprises:
after determining, according to attribute information of the cloud desktop logged in by the terminal, whether to migrate user data, reading the user data in a storage unit corresponding to the service node.

7. The method according to claim 6, wherein the storage unit corresponding to the service node comprises: a shared storage unit corresponding to the home service node, and a local storage unit corresponding to the roaming service node; and
reading the user data in the storage unit corresponding to the service node comprises:
when it is determined that the user data is stored in the local storage unit corresponding to the roaming service node, reading the user data from the local storage unit corresponding to the roaming service node; and
when it is determined that the user data is not stored in the local storage unit corresponding to the roaming service node, reading the user data from the shared storage unit corresponding to the home service node,
or, wherein migrating the hotspot data comprises: migrating the hotspot data stored in the storage unit corresponding to the home service node to the storage unit corresponding to the roaming service node.

8. (canceled)

9. The method of claim 6, further comprising:
after migrating the hotspot data, acquiring updated data fed back from the terminal.

10. The method according to claim 9, further comprising:
after acquiring the updated data fed back from the terminal, acquiring a cache identifier sent from a management node; and
determining, according to the cache identifier, whether to cache the updated data to the service node.

11. The method according to claim 10, wherein determining, according to the cache identifier, whether to cache the updated data to the service node comprises:
when it is determined that the cache identifier indicates that the updated data is to be cached to the service node, caching the updated data to a local storage unit corresponding to the roaming service node, and synchronizing the updated data to a shared storage unit corresponding to the home service node; and
when it is determined that the cache identifier indicates that the updated data is not to be cached to the service node, transmitting the updated data to the shared storage unit corresponding to the home service node.

12. The method according to claim 11, wherein caching the updated data to the local storage unit corresponding to the roaming service node comprises:
accumulating access popularity corresponding to the updated data according to access information corresponding to the updated data; and
caching the updated data and the corresponding access popularity to the local storage unit corresponding to the roaming service node.

13. The method according to claim 11, wherein the shared storage unit corresponding to the home service node comprises: any one or more of a network attached storage device, a distributed file storage device, or a cloud storage; and
the local storage unit corresponding to the roaming service node comprises: any one or more of a redundant array of independent disks, a distributed storage device or a hard disk.

14. The method according to claim 6, further comprising:
after migrating the hotspot data and when it is determined that the service node comprises the home service node and the roaming service node, clearing data in a local storage unit corresponding to the roaming service node.

15. The method according to claim 14, wherein clearing data in the local storage unit corresponding to the roaming service node comprises:
determining a cache proportion according to an acquired capacity of a cache space in the local storage unit corresponding to the roaming service node and a cached data volume;
determining, according to the cache proportion and a preset clearing threshold, whether to clear data in the cache space of the local storage unit corresponding to the roaming service node; and
when it is determined to clear data in the cache space of the local storage unit corresponding to the roaming service node, clearing the data in the cache space of the local storage unit corresponding to the roaming service node according to access popularity and a preset popularity threshold of the data in the cache space of the local storage unit corresponding to the roaming service node.

16. The method according to claim 1, wherein the attribute information of the cloud desktop comprises: a desktop roaming identifier; and
determining, according to attribute information of the cloud desktop logged in by the terminal, whether to migrate user data comprises:
determining to migrate the user data when it is determined that the desktop roaming identifier corresponding to the cloud desktop logged in by the terminal represents that a user account logged in the cloud desktop supports data roaming.

17. A cloud desktop data migration method, comprising:
generating configuration information according to acquired attribute information of a cloud desktop logged in by a terminal; and
sending the configuration information to a service node so that the service node determines, according to the attribute information of the cloud desktop logged in by the terminal, whether to migrate user data, and when it is determined to migrate the user data, determines hotspot data according to access popularity corresponding to the user data, and migrates the hotspot data.

18. The method according to claim 17, wherein the configuration information further comprises:
any one or more of a desktop roaming identifier, a storage address, a migrated volume of the user data, a cache identifier, a capacity of a cache space of a service node, a clearing period of the cache space of the service node, or a preset clearing threshold;
wherein the desktop roaming identifier represents whether a user account logging in the cloud desktop supports data roaming, the cache identifier represents whether to cache updated user data, and the capacity of the cache space of the service node is larger than or equal to the migrated volume of the user data.

19. A service node, comprising a processor and a storage having a computer program stored thereon which, when executed by the processor, cause the processor to:
determine, according to attribute information of a cloud desktop logged in by a terminal, whether to migrate user data, wherein the attribute information of the cloud desktop logged in by the terminal is information determined according to acquired configuration information of a management node;
determine, when it is determined to migrate the user data, hotspot data according to access popularity corresponding to the user data; and
migrate the hotspot data.

20. A management node, comprising a processor and a storage having a computer program stored thereon which, when executed by the processor, cause the processor to perform the method of claim 17.

21. A server, comprising:
at least one of a service node or a management node; wherein
the service node is configured to implement the cloud desktop data migration method according to claim 1; and
the management node is configured to:
generate configuration information according to acquired attribute information of a cloud desktop logged in by a terminal; and
send the configuration information to a service node so that the service node determines, according to the attribute information of the cloud desktop logged in by the terminal, whether to migrate user data, and when it is determined to migrate the user data, determines hotspot data according to access popularity corresponding to the user data, and migrates the hotspot data.

22. (canceled)

23. A non-transitory computer-readable storage medium having a computer program stored thereon which, when executed by a processor, causes the cloud desktop data migration method according to claim 1 to be implemented.
